(19) United States
(12) Patent Application Publication
(10) Pub. No.: US 2011/0256416 A1
(43) Pub. Date: Oct. 20, 2011

(54) METHOD OF FORMING AN ARTICLE USING A POWDER LAYER MANUFACTURING PROCESS

(75) Inventors: Carl David Monnington BRANCHER, Abergavenny (GB); Trevor J. ILLSTON, Worcestershire (GB)

(73) Assignee: MATERIALS SOLUTIONS, Birmingham (GB)

(21) Appl. No.: 13/069,742

(22) Filed: Mar. 23, 2011

Related U.S. Application Data
(60) Provisional application No. 61/323,942, filed on Apr. 14, 2010.

(51) Int. Cl. B32B 33/00; B32B 15/00; C04B 35/64

(52) U.S. Cl. 428/544; 264/113

(57) ABSTRACT

A method of forming an article using a powder layer manufacturing process includes providing a first support, forming a part of an article up to a level at or beneath the lowest point of a to-be-formed part which has a base spaced from the first support, locating a preformed support beneath the location in which the to-be-formed part will lie so that part can be formed on the preformed support and wherein the preformed support does not project beyond the level, and removing the preformed support when the to-be-formed part and/or the article is completed.

### BACKGROUND

This invention relates to a method of forming an article using a powder layer manufacturing process.

Power layer manufacturing processes operate by forming successive build layers of powder on a support and selectively locally sintering, melting or otherwise binding the powder so as to form an article. Examples of such processes are described in U.S. Pat. No. 4,863,538 and U.S. Pat. No. 4,247,508.

Typically these processes are carried out using metal powders. Unlike plastics, metals have a rapid transition from solid to low viscosity liquid and back to solid when heated and cooled. All metals, and most alloys, also have relatively large co-efficiency of thermal expansion. As a result, and particularly when there is no significant heating of the powder bed, the conversion of metal powder into an element of the solid part by melt and re-solidification creates compressive stresses in the part. This in turn can cause mechanical deformation, if the part is not rigidly restrained. Also, without a solid surface to wet upon, the molten metal will tend to bend up under tensile stress and will not commence the building of a solid part from a layer of unrestrained powder.

A consequence of this is that in building parts in metal, each element of the desired metal structure must be supported by an element of a previous layer and the entire part must be restrained during building. It is therefore typical to build the first layer on a base plate, which must subsequently be removed. This base plate must also be sufficiently stiff so as to restrain the tendency to relieve mechanically the inherent stress caused by cooling and by re-solidification of the metal from the powder bed into a solid part. It is also known that powder layer manufacture may be used to repair an existing article or build up from a preform. In either case the existing article or preform (which subsequently forms the lower part of the completed article) must fulfil the functions of a baseplate as described here.

Because of these issues, the ideal is to modify the design of a part so that as little support structure is required to build the part as possible. However, not all designs enable this approach to be used.

A typical prior art approach is illustrated in FIG. 1. An article to be formed is generally indicated at 1 and is shown in cross section. It will be seen that a base plate 2 is provided on which an element A is directly built. Elements B and C, which begin above the base plate, however, need separate support and these are shown at 4B and 4C. These elements B and C are typically built up using the same process as is used to form element A and then have to be removed. This can cause issues with delicate edges such as veins and further the need to form 4B and 4C from the powder 3 means that the process is slower due to more activity from the laser.

### SUMMARY

From one aspect the invention consists in the method of forming an article using a powder layer manufacturing process including:

(a) providing a first support;

(b) forming a part of an article up to a level at or beneath the lowest point of a to-be formed part, which has a base from the first support;

(c) locating a pre-formed support beneath the location in which the to-be formed part will lie such that that part can be formed on the preformed support and wherein the preformed support does not project beyond the level; and

removing the preformed support when the to-be formed part and/or article is completed.

The preformed support may be mechanically, thermally, chemically or electrochemically removed. Preferably the preformed support is made of a different material from the article, for example to enhance that removal. Thus for example the material of the preformed support may be softer and/or have a different thermal coefficient of expansion than the material of the article.

Although the invention has been defined above it is to be understood that it includes any inventive combination of the features set out above when the following description. It further includes any article made by the base plate.

### BRIEF DESCRIPTION OF THE DRAWINGS

FIG. 1 is a cross-sectional view for use in describing a conventional example of forming an article.

FIG. 2 is a cross-sectional view for use in describing the forming of an article according to an embodiment of the invention.

FIG. 3 is a cross-sectional view for use in describing the forming of an article according to an embodiment of the invention.

FIG. 4 is a plan view of the article illustrated in FIG. 3.

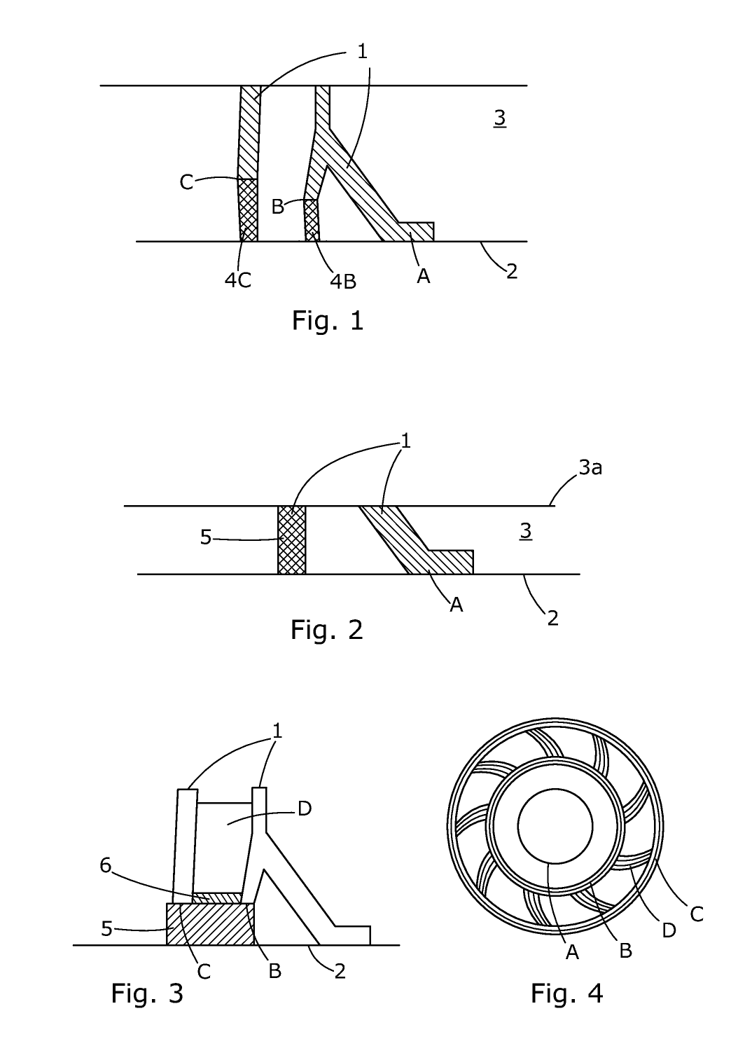

### DETAILED DESCRIPTION

Turning to FIG. 2. An article A is constructed using the powder 3 in the manner known, on a base plate 2. The process continues until the level 3A is reached at which point a preformed support 5 is inserted into the powder 3 and the process continues. In the case shown in FIG. 2 the element B could then be built up. Multiple preforms can be inserted to allow the construction of elements C and D. So for example in FIG. 3 a larger preformed 5 subsequently supports a preformed 6 in order to form the vein D. The preforms may themselves be of different materials. For perspective, is a plan view of the article illustrated in FIG. 3, such that FIG. 3 is in effect a partial section view along a radius of FIG. 4

The use of these preforms can have several advantages. For example if the article is being made from a very hard material, e.g. cobalt chrome, it can be extremely difficult to machine that material. If the preforms are made of mild steel, then they can much more readily be machined away. Alternatively, the preform may be removed by thermal, chemical or electrochemical methods by selecting appropriate materials. If a line of weakness can be created between the preform and the built part, then removal may be assisted.

What is claimed:

1. A method of forming an article using a powder layer manufacturing process including:
(a) providing a first support;
(b) forming a part of an article up to a level at or beneath the lowest point of a to-be-formed part which has a base spaced from the first support;
(c) locating a preformed support beneath the location in which the to-be-formed part will lie so that part can be formed on the preformed support and wherein the preformed support does not project beyond the level; and
(d) removing the preformed support when the to-be-formed part and/or the article is completed.

2. A method as claimed in claim 1 wherein preformed support is mechanically thermally chemically or electro-chemically removed.

3. A method as claimed in claim 1 wherein the preformed support is made of a different material from the article.

4. A method as claimed in claim 3 wherein the material or preformed support is softer and/or has a different thermal coefficient of expansion than the material of the article.

5. A method of forming a part by metal (alloy) additive layer process whereby a removable preform is inserted into the powder bed and an element of the part is built upon it.

6. A method according to claim 5 wherein the additive layer process has a powder bed.

7. A method according to claim 5 wherein the preform removal method is by mechanical, thermal, chemical or electrochemical methods.

8. A method according to claim 5 wherein the preform is reusable.

9. A method according to claim 5 wherein the preform is selectively removed.

10. A method according to claim 5 wherein a preform is mounted on a preform.

11. A preform used in a metal (alloy) additive layer process to provide support for an element of a part that commences above the level of the baseplate.

12. A preform according to claim 11 wherein the additive layer process has a powder bed.

13. A preform according to claim 11 wherein the preform is a metal or metal alloy.

14. A preform according to claim 11 wherein the material of the preform can be selectively removed from the part.

15. A preform according to claim 11 wherein the material of the preform is easier to mechanically remove that the material of the part built by the additive layer process.
